(19) United States
(12) Patent Application Publication
(10) Pub. No.: US 2012/0127955 A1
(43) Pub. Date: May 24, 2012

(54) METHOD FOR ENERGY-EFFICIENT SCANNING TO ENABLE SEAMLESS LAYER-2 VERTICAL HANDOFFFS BETWEEN WIRELESS BROADBAND NETWORKS

(76) Inventors: Shashidhar R. Gandham, Fremont, CA (US); Amit Shukla, San Jose, CA (US)

(21) Appl. No.: 13/021,758

(22) Filed: Feb. 6, 2011

Related U.S. Application Data
(60) Provisional application No. 61/337,743, filed on Feb. 10, 2010.

(51) Int. Cl. H04W 36/00

(52) U.S. Cl. 370/331

(57) ABSTRACT

A mechanism that minimizes the frequency and interval of mobile device scans while not impacting the ability of the devices to seamlessly move across disparate wireless networks is disclosed. More specifically the method involves creating a map of tower/network identifiers and channels of operation between different wireless networks. Using this information a mobile device can schedule its scans on multiple wireless interfaces in an energy-efficient and on-demand manner.

### CROSS-REFERENCE TO RELATED APPLICATION

The present application claims the benefit of previously filed co-pending Provisional Patent Application Ser. No. 61/337,743 filed Feb. 10, 2010.

### FIELD OF THE INVENTION

This invention addresses the need to have a method that minimizes the frequency and interval of mobile device scans while not impacting the ability of the devices to seamlessly move across disparate wireless networks. More specifically the method involves creating a mapping of tower/network identifiers and channels of operation between different wireless networks. Using this information a mobile device can schedule its scans on multiple wireless interfaces in an energy-efficient and on-demand manner.

### BACKGROUND OF THE INVENTION

The invention disclosed in this application uses any type modulation and more particularly is shown in the preferred embodiment using a method of modulation now known by its commercial designation, xMax. This new wireless physical layer technology developed by xG Technology Inc., referred to as xMAX, enables extremely low power Omni-directional transmissions to be received in a wide area. Using xMAX, significant bandwidth can be made available for supporting various wireless applications. Voice Over IP (VoIP) based cellular services are now being developed using xMAX. In xMAX-based cellular networks both the base station and the handsets will be equipped with an xMAX transceiver. A mobile device (xMAX handset) in such a network will be free to move in an area covered by multiple xMAX base stations. Although this energy efficient scanning method for layer-2 vertical handoffs between differing wireless broadband networks is disclosed in the preferred embodiment as being used in these types of integer cycle and pulse modulation systems it can be implemented on any broad band wireless technologies like WiMax, WiBro, Wi-Fi, 3GPP and HSDPA, or any other type of wired or wireless voice or data systems.

A heterogeneous MAC protocol proposed to support VoIP traffic in xMAX wireless networks has been discussed in previously filed patent applications U.S. Ser. Nos.: 12/069,057; 12/070,815; 12/380,698; 12/384,546; 12/386,648; 12,387,811; 12/387,807; 12/456,758; 12/456,725; 12/460,497; 12/583,627; 12/583,644; 12/590,472; 12/590,469; 12/590,931; 12/653,021; 12/653,007; 12/657,324; 12/803,380; and, 12/804,058 which are incorporated by reference into this disclosure. In the heterogeneous MAC protocol described in these applications, guaranteed timeslots are assigned to forward VOIP packets, temporary timeslots are assigned to forward data packets and contention based access is used to exchange control messages. Note that this heterogeneous MAC protocol is used here as a reference protocol and similarly xMAX as a reference wireless network. The idea of an energy efficient scanning method for layer-2 vertical hand-offs between differing wireless broadband networks as described herein can be used in other relevant systems.

### BRIEF SUMMARY OF THE INVENTION

The invention disclosed in this application was developed for and is described in the preferred embodiment as being used in any integer cycle or impulse type modulation and more particularly a method of modulation known by its commercial designation, xMAX, but can be implemented on Wi-Fi, 3GPP, HSDPA or any other type of wired or wireless voice or data systems.

The latest mobile devices are capable of simultaneous operation in multiple wireless broadband modes. xMAX, Wi-Fi, LTE, WiBro and WiMAX are some examples of wireless broadband networks. To fully exploit the presence of multiple broadband network interfaces a mobile device needs to use the best possible wireless interface. To support seamless connectivity across disparate wireless broadband networks the latency for handoffs need to be minimized. Handoff latency is particularly critical for interactive and real time applications like mobile VOIP and video streaming. Scanning for target channels on different interfaces contribute to a significant portion of the hand-off latency. To minimize this latency a mobile device can schedule to scan channels on all the available modes even when the channel on the current interface is acceptable. However, continuously monitoring on all the available wireless interfaces will significantly drain the battery power of the mobile devices and reduces the standby time. Moreover, not all networks might be present at the current location of the mobile device. Scanning on an interface where no service might be available is both a latency and an energy intensive operation.

Therefore it is an object of this invention to have a method that minimizes the frequency and interval of the mobile device scans while not impacting the ability of the devices to seamlessly move across disparate wireless networks. The method involves creating a mapping of tower/network identifiers and channels of operation between different wireless networks. Using this information a mobile device can schedule its scans on multiple wireless interfaces in an energy efficient and on demand manner.

For a fuller understanding of the nature and objects of the invention, reference should be made to the following detailed description taken in connection with the accompanying drawings.

### DESCRIPTION OF THE DRAWINGS

For a fuller understanding of the nature and objects of the invention, reference should be made to the accompanying drawings, in which:

FIG. 1 is a diagram showing a system architecture for Wi-Fi to xMAX handoffs; and,

FIG. 2 is a network MAP for xMAX to Wi-Fi handoffs.

### DETAILED DESCRIPTION OF THE INVENTION

Wireless broadband networks have become increasingly ubiquitous. For example, most residential, commercial and educational establishments provide Wi-Fi access. Wi-Fi provides broadband data rates ranging up to several tens of mega bits per second. The coverage area of Wi-Fi access points typically ranges up to a 200 feet. In recent times relatively long-range wireless broadband services like xMAX, LTE, WiMAX and WiBro are emerging as popular alternatives for mobile Internet connectivity. Many recently designed mobile devices are equipped with one or more of these interfaces. For example, the TX60 handset designed by xG Technology, Inc has the capability to operate in both xMAX and Wi-Fi mode. Similarly, most of the smart phones have a Wi-Fi interface in addition to 3G/4G cellular connectivity.

The ability to seamlessly handoff across multiple disparate wireless networks will improve the coverage and connectivity for mobile devices. Gaps in coverage on one network might be covered by other networks. For example, indoor penetration issues with cellular networks are well known. If the mobile devices can handoff to an indoor Wi-Fi network then the coverage gaps can be closed. In addition the ability to perform vertical handoffs will enable some of the traffic on an overloaded network be offloaded to networks which are relatively lightly loaded. For example, traffic generated by mobile devices can be routed over Wi-Fi whenever possible thus alleviating capacity related issues in cellular networks.

To support seamless mobility across different networks the mobile devices should be able to select the best available channel regardless of which network interface channel they are associated with. The selection decision should be made within a few milliseconds from the moment the need to perform a handoff arises. To make such decisions almost instantaneously the mobile device should be aware of the channel conditions in all the available networks. A simple solution involves performing proactive scanning on all the channels. Proactively scanning on all the wireless channels on a continuous basis is an energy intensive task. It results in reduced standby times of the mobile devices. Hence, it is not an acceptable solution. An alternative is to start scanning on other wireless interfaces only when the channel conditions on the current wireless interface deteriorate. However, as the latency involved in scanning is very high, this approach is also not acceptable.

The basic idea in the invention of this disclosure involves scanning a wireless interface only when the mobile device is certain to identify a network on that particular interface. For example, a dual mode device that has xMAX and Wi-Fi interfaces can scan for Wi-Fi networks only when it is certain that it can find a Wi-Fi network. The main challenge in implementing this solution is availability of geo-location information of Wi-Fi access points and of the mobile devices. If such information is available then a mobile device that is in xMAX mode will turn on its Wi-Fi interface only if there is a Wi-Fi access point in its vicinity. At all other times it can power down its Wi-Fi interface.

Building a geo-location information database that contains a list of all access points that each mobile device can use is an impractical approach. Though mobile devices can obtain their location through GPS, the indoor performance of GPS is not reliable. The disclosure of this application proposes an approach that needs neither centrally managed geo-location information nor the mobile device location information.

The approach involves mapping of tower/network identifiers and channels of operation between different wireless networks. Using this information a mobile device can schedule its scans on other wireless interfaces in an efficient and on demand manner. For example, whenever a mobile device is communicating with a Wi-Fi it can turn on its other interfaces and scan the channels on that interface. It can the store the information about the channels and towers/base station identified on each of the interfaces along with the current Wi-Fi access point. Note that this scanning needs to be performed only once per access point, or periodically, such as once over several days. The next time when the mobile device is on another wireless network and observes the same combination of tower/base station identifiers and channels it can conclude that it is in the vicinity of the Wi-Fi access point. It can then turn on its Wi-Fi interface and start searching for it. All the operations can be implemented such that the user never will have to manually schedule scanning.

Network Mapping is a process where two networks are linked together using unique identifiers (e.g. MAC address, Network IDs) to create an associative Network Map. An entry is created when the device detects two networks simultaneously. The entry consists of the unique identifier of each network and will have options for other parameters such as Signal Quality, etc. Thus, the two networks are linked together on the basis of location. The device will periodically check its Network Map to find suitable networks.

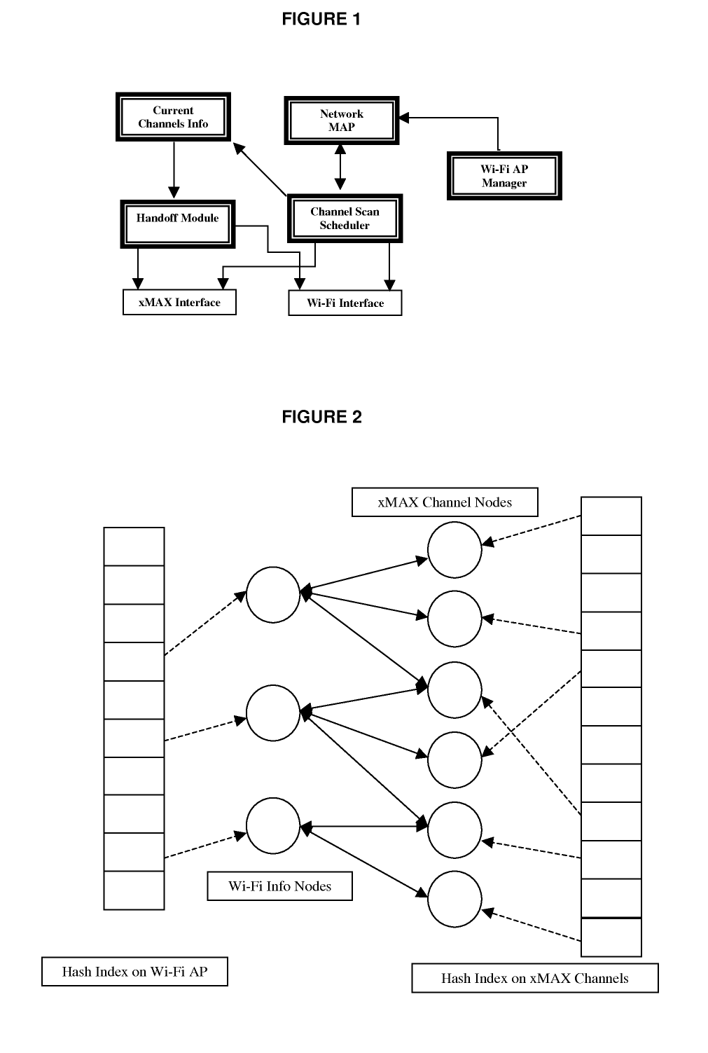

Discussed below is how the current invention can be employed for efficient scanning to enable handoffs between xMAX and Wi-Fi networks. FIG. 1 illustrates the example architecture of implementing this invention in a mobile device that is equipped with xMAX and Wi-Fi. In this diagram the xMAX interface and the Wi-Fi interface represent the respective network interface cards on the mobile device. The Wi-Fi AP Manager module is used to add/register access point information with the mobile device. The Network Map module keeps track of mapping between various channels on xMAX and Wi-Fi interfaces. The Channel Scan Scheduler module makes decisions on when to turn on an alternative interface and schedule the channel scans. The module titled Current Channels Info maintains the latest information on available channels. The information maintained includes RSSI and SiNR on available channels. The instantaneous estimates of RSSI and SiNR are used to maintain weighted average values of both the metrics. The Handoff module is responsible to initiate vertical handoffs across the networks.

Most of the Wi-Fi access points are secured and need a user to configure the mobile device with security related information like a WEP Key. Whenever a user adds a new Wi-Fi access point profile the Wi-Fi AP manager is notified about it. Subsequently this module will add the access point information to the Network Map module.

On receiving information about a new access point the Network Map module will request a channel scan on the xMAX interface through the Scan Scheduler module. During the scanning process the following information is gathered: (i) List of xMAX channels available and (ii) 32-bit ID of the base station that is operating each of the channels. Note that Wi-Fi coverage is limited to few hundred feet. On the other hand coverage of the xMAX network might span several miles. Hence the set of channels identified by channel scan will be the same when the mobile device is within connecting range of the Wi-Fi access point. The Network Map module is updated with the list of xMAX channels discovered during scanning.

When the handset is in Wi-Fi mode it is monitoring its current channel condition. If the SiNR on the current channel is strong enough then the Scan module will not schedule to scan the xMAX channels. This will ensure that continuous scanning of the xMAX channels does not waste the battery power. If the SiNR on the Wi-Fi interface is low, say less than 6 dB, then the Scan module will schedule to scan the xMAX interface. Note that 6 dB is stated as an example for the threshold. This could vary in the actual implementation. One refers to the Network Map to find out the exact list of xMAX channels that are expected to be found within the vicinity of the current access point. Scans are scheduled on these channels only. By scheduling scans on an expected subset of channels one conserves the battery power on the mobile device. The results of the scan module are sent to the Current Channel Info module. Note that during the scanning process the mobile device does not register with any of the xMAX base stations. The mobile device is only trying to acquire the beacon on the channel and estimate the SiNR on that particular channel.

The Handoff module periodically checks the current status of all available channels. If the weighted average of the SiNR on a xMAX channel is better than the weighted average SiNR on the Wi-Fi interface then the mobile device will initiate the handoff process. The handoff to the xMAX interface will involve layer-2 registration with the xMAX base station. In addition higher layer signaling like a RE-INVITE or mobile-IP signaling might be involved. Issues related to higher layer signaling are beyond the scope of this invention.

In the above description SiNR is used as the metric to trigger handoffs from a Wi-Fi network to a xMAX network. Alternatively one can use other relevant metrics like number of collisions, packet error rate, latency, and jitter to trigger the handoff process. These metrics are particularly relevant when the mobile device is in Wi-Fi mode. Due to the contention-based nature of the Wi-Fi MAC protocol one might notice good SiNR but high latency. In such scenarios some application like VoIP might perform better if switched to a xMAX interface. Hence the handoff trigger can be based on metrics other than SiNR.

The handoff process from xMAX to Wi-Fi is very similar to the process used for Wi-Fi to xMAX handoffs. However the threshold for handoff might be different due to the following requirements:
To offload the traffic from a cellular network one might want the handset to switch to a Wi-Fi network even when the SiNR on the xMAX interface is good enough.
If the handset is moving then one might want the handset to stay on the xMAX interface even when there might be Wi-Fi access point in the vicinity that can provide a stronger signal.
   Note that the above two requirements are conflicting with each other. The first requirement states that a handoff should be initiated even when SiNR on a xMAX interface is strong. The second requirement states that a handoff should not be initiated even when the SiNR on a xMAX interface is weaker.

To meet the first requirement the preferred embodiment marks the most often visited Wi-Fi access points as home networks. Whenever the mobile device comes into the vicinity of a home network it will initiate a vertical handoff even if the channel condition on the xMAX interface is very good. One can rely on the user to mark certain Wi-Fi networks, like residence or office networks, as home networks. Alternatively one can automate the process of identifying home networks. The mobile device needs to maintain the number of times and duration spent at each Wi-Fi network. Based on certain predetermined criteria one can mark a subset of access points as home access points. For example one can decide that a Wi-Fi network is a home network it is visited about 5 times a week and the average time spent on each visit is at least 10 minutes. Note that one can formulate various other combinations for selection of home networks all of which would be within the scope of this invention.

But if one does not consider the second requirement the mobile device might have to initiate too many vertical handoffs. Note that the coverage of the Wi-Fi access points is limited to few hundred feet, whereas the coverage in xMAX might span several miles. Consider a case of mobile device moving at speed of 45 miles hour. It might potentially pick several public access points along the way with stronger signal strength. If the mobile device were to handoff to an access point then, within few seconds, it will move out of coverage of that access point. As a result it will need to initiate a handoff back from Wi-Fi to xMAX. If, on the other hand, the mobile devices waits for a longer duration before initiating the first handoff then the two vertical handoffs will have been avoided.

To minimize such unnecessary vertical handoffs while a handset is moving in xMAX node the preferred embodiment introduces a relatively longer hysteresis timer before which a handoff will not be initiated. When the mobile device finds a Wi-Fi access point with better signal than a xMAX interface the hysteresis timer starts. If the signal strength on Wi-Fi interface continues to be better until the timer expires then handoff is initiated from the xMAX to the Wi-Fi interface. The preferred embodiment sets the hysteresis timer in the order of several seconds. Note that setting a very high value for the hysteresis timer impacts the ability to perform seamless handoffs. On the other hand if this value is set to too low then the number of unnecessary vertical handoffs will increase. This parameter needs to be picked carefully based on field testing.

What follows is and explanation of the utility of the Network Map in enabling seamless mobility across xMAX and Wi-Fi networks. As explained above every time Wi-Fi access point information is added to the mobile device one identifies the set of xMAX channels that are accessible in the vicinity. The relation between Wi-Fi access points and xMAX channels is stored using a bi-partite graph as shown in FIG. 2. Here one has one node corresponding to each Wi-Fi access point (SSID) and one node corresponding to each xMAX channel (xMAX channel, base station ID). Note that if the same xMAX channel is found on multiple base stations then one will have multiple nodes in the bi-partite graph. The bi-directional links between a Wi-Fi node and a xMAX node indicates that it is highly likely that a mobile device can access both the Wi-Fi network and the corresponding xMAX channel from the same location.

This invention disclosure describes an approach for energy efficient scanning of multiple disparate wireless network interfaces to support seamless vertical handoffs. The approach involves building a network map of tower/network identifiers and channels of operation between different wireless networks. This map can be built by the mobile devices in isolation or in coordination with the network to form a more accurate global coverage database. Using the network map a mobile device schedules scans on alternative interfaces only when it is sure to find prospective channels on the alternative interfaces. Using this approach one can improve the standby time of mobile devices that can seamlessly roam across multiple broadband wireless networks.

Since certain changes may be made in the above described method that minimizes the frequency and interval of the mobile device scans while not impacting the ability of the devices to seamlessly move across disparate wireless networks without departing from the scope of the invention herein involved, it is intended that all matter contained in the description thereof or shown in the accompanying figures shall be interpreted as illustrative and not in a limiting sense.

What is claimed is:

1. A method for energy efficient scanning of multiple alternative wireless network interfaces to support handoffs by a mobile device among alternative wireless networks comprising;
said mobile device periodically scanning and storing a network map of tower/network identifiers and channels of operation of available alternative wireless network interfaces while located at particular wireless access locations; and,
said mobile device using said network map to schedule scanning on said available alternative wireless network interfaces only when said mobile device is at a particular wireless access location and is sure to find prospective channels on said alternative wireless network interfaces available for handoff.

2. The method of claim 1 wherein said network map includes signal quality parameters determined during said periodic scanning that are used to determine availability for handoff.

3. The method of claim 1 wherein a hysteresis timer is used to determine availability for handoff.
